(19) United States
(12) Patent Application Publication
(10) Pub. No.: US 2015/0092626 A1
(43) Pub. Date: Apr. 2, 2015

(54) METHODS AND SYSTEMS FOR TRANSMITTING AND RECEIVING UPLINK CONTROL CHANNEL INFORMATION

(71) Applicants: Fang-chen CHENG, Randolph, NJ (US); Sigen YE, New Providence, NJ (US); Matthew P J BAKER, Canterbury (GB)

(72) Inventors: Fang-chen CHENG, Randolph, NJ (US); Sigen YE, New Providence, NJ (US); Matthew P J BAKER, Canterbury (GB)

(21) Appl. No.: 14/304,457

(22) Filed: Jun. 13, 2014

Related U.S. Application Data
(60) Provisional application No. 61/883,553, filed on Sep. 27, 2013.

(51) Int. Cl. H04W 72/12; H04L 5/14

(52) U.S. Cl. CPC H04W 72/1284; H04L 5/14
USPC 370/280

(57) ABSTRACT

At least one example embodiment discloses a method of receiving uplink control information in a communication system having at least a first and a second cell in communication with a user equipment (UE), the first cell being using a time-division duplex (TDD) carrier and configured to communicate using TDD transmissions and the second cell using a frequency-division duplex carrier and configured to communicate using FDD transmissions, one of the first and second cells being a primary serving cell to the UE. The method includes receiving uplink control channel information on the frequency-division duplex carrier independent of which one of the first and second cells is the primary serving cell.

### CROSS-REFERENCE TO RELATED APPLICATIONS

This non-provisional patent application claims priority under 35 U.S.C. §119(e) to provisional U.S. application No. 61/883,553 filed on Sep. 27, 2013 in the United States Patent and Trademark Office, the entire contents of which are incorporated herein by reference.

### BACKGROUND

Wireless cellular networks may include several cells, where each cell includes a base station that provides mobile communications and network services to mobile devices or user equipment (UE). In the wireless cellular networks, signals from one or more UEs in a cell coverage area of a base station are received by the base station, which then connects a call to a land-line telephone network and/or connects the UE to a network, such as the internet. In typical wireless cellular systems, a UE is serviced by one base station.

Wireless networks using the long-term evolution (LTE) standard may employ features, such as Carrier Aggregation (CA) and Coordinated Multi-Point Operation (CoMP), that allow UEs to be serviced by more than one base station. For example, when a UE works under the CA mode, the UE may be served by two or more cells, where one of the cells acts as a primary serving cell, and other cells act as secondary serving cells. Similarly, CoMP allows UEs to be served by more than one base station in order to enhance quality of service (QoS) on the perimeter of a serving cell.

### SUMMARY

In Rel-10/11 carrier aggregation (CA) of LTE (FDD-FDD or TDD-TDD CA), a physical uplink control channel (PUCCH), including hybrid automatic request (HARQ) for the physical downlink shared channel (PDSCH), channel state information (CSI) feedback and scheduling request (SR), is always transmitted by a base station of a primary cell (or “PCell”) only, which carries uplink control information for the primary cell and one or more secondary cells (or “SCell”). For frequency-division duplexing (FDD), each subframe has both downlink (DL) and uplink (UL), while for time-division duplexing (TDD), each subframe is either DL or UL. This creates some issues in scheduling and HARQ timing for TDD-FDD CA.

To resolve these issues, at least one example embodiment discloses transmitting the PUCCH using a FDD carrier when TDD-FDD CA is used, regardless of whether the FDD carrier is being used by a PCell or SCell. By transmitting the PUCCH using an FDD carrier when TDD-FDD CA is used, regardless of whether the FDD carrier is configured as a PCell or SCell, it allows the use of the PUCCH in certain subframes when the PUCCH cannot be transmitted in a TDD primary cell.

At least one example embodiment discloses a method of receiving uplink control information in a communication system having at least a first and a second cell in communication with a user equipment (UE), the first cell using a time-division duplex (TDD) carrier and configured to communicate using TDD transmissions and the second cell using a frequency-division duplex carrier and configured to communicate using FDD transmissions, one of the first and second cells being a primary serving cell to the UE. The method includes receiving uplink control channel information on a frequency-division duplex carrier independent of which one of the first and second cells is the primary serving cell.

In an example embodiment, the communication system receives the uplink control channel information only on frequency-division duplex communications.

In an example embodiment, the second cell is a secondary serving cell.

In an example embodiment, the second cell is a small cell and the first cell is a macro cell.

In an example embodiment, configuring communications with the UE such that the first cell is the primary serving cell.

In an example embodiment, the control channel information includes channel state information (CSI).

In an example embodiment, the control channel information includes a scheduling request (SR).

In an example embodiment, multiple FDD cells are aggregated with at least one TDD cell, and an uplink control channel is transmitted in one of the FDD cells.

In an example embodiment, which FDD cell carries the uplink control channel is pre-defined by a network element.

In an example embodiment, which FDD cell carries the uplink control channel is signaled using higher layer signaling.

In an example embodiment, the control channel information includes HARQ feedback for a downlink data channel for the first cell and the second cell.

In an example embodiment, the timing of HARQ feedback for FDD cell follows the timing of an FDD cell.

In an example embodiment, the timing of HARQ feedback for TDD cell follows the timing of a TDD cell.

In an example embodiment, the timing of HARQ feedback for a TDD cell follows the timing of an FDD cell.

At least one example embodiment discloses a network element including a memory and a processor configured as part of at least a first and a second cell in communication with a user equipment (UE), the first cell using a time-division duplex (TDD) carrier and configured to communicate using TDD transmissions and the second cell using a frequency-division duplex carrier and configured to communicate using FDD transmissions, one of the first and second cell being a primary serving cell to the UE, and the processor configured to control the UE to transmit uplink control channel information using the frequency-division duplex carrier independent of which of the first and second cell is the primary serving cell.

In an example embodiment, the processor is configured to receive the uplink control channel information only on the frequency-division duplex carrier.

In an example embodiment, the second cell is a secondary serving cell.

In an example embodiment, the second cell has a first coverage area and the first cell has a second coverage area, the second coverage area being larger than the first coverage area.

In an example embodiment, the second cell has a first coverage area and the first cell has a second coverage area, the second coverage area being smaller than the first coverage area.

In an example embodiment, the first cell is a secondary serving cell, the processor is configured to establish communications with the UE and the first cell such that the first cell is the primary serving cell.

In an example embodiment, the control channel information includes HARQ feedback for a downlink data channel.

In an example embodiment, the control channel information includes channel state information (CSI).

In an example embodiment, the control channel information includes a scheduling request (SR).

At least another example embodiment discloses a user equipment (UE) including a memory, a processor configured to operate with at least a first and a second cell in communication with the UE, the first cell using time-division duplex (TDD) carrier and configured to communicate using TDD transmissions and the second cell using a frequency-division duplex carrier and configured to communicate using FDD transmissions, one of the first and second cell being a primary serving cell to the UE and a having a transmitter configured to transmit uplink control channel information using the frequency-division duplex carrier independent of which one of the first and second cells is the primary serving cell.

In an example embodiment, the transmitter is configured to transmit the uplink control channel information only on the frequency-division duplex carrier.

In an example embodiment, the uplink control channel information includes channel state information (CSI).

In an example embodiment, the uplink control channel information includes a scheduling request (SR).

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIG. 1A illustrates a wireless communication system according to an example embodiment;

FIG. 1B illustrates a base station configured to implement carrier aggregation according to an example embodiment;

FIG. 2 illustrates uplink and downlink subframes for a PCell and an SCell;

FIG. 3 illustrates a method of receiving uplink control information according to an example embodiment;

FIG. 4 illustrates an example embodiment of a base station shown in FIG. 1; and

FIG. 5 illustrates an example embodiment of a user equipment shown in FIG. 1.

### DETAILED DESCRIPTION

Various example embodiments will now be described more fully with reference to the accompanying drawings in which some example embodiments are illustrated.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), digital signal processors (DSPs), application-specific-integrated-circuits, field programmable gate arrays (FPGAs) computers or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

As disclosed herein, the term “storage medium”, “storage unit” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

As used herein, the term “user equipment” or “UE” may be synonymous to a user equipment, mobile station, mobile user, access terminal, mobile terminal, user, subscriber, wireless terminal, terminal and/or remote station and may describe a remote user of wireless resources in a wireless communication network. Accordingly, a UE may be a wireless phone, wireless equipped laptop, wireless equipped appliance, etc.

The term “base station” may be understood as a one or more cell sites, base stations, nodeBs, enhanced NodeBs, access points, and/or any terminus of radio frequency communication. Although current network architectures may consider a distinction between mobile/user devices and access points/cell sites, the example embodiments described hereafter may also generally be applicable to architectures where that distinction is not so clear, such as ad hoc and/or mesh network architectures, for example.

Communication from the base station to the UE is typically called downlink or forward link communication. Communication from the UE to the base station is typically called uplink or reverse link communication.

Primary serving base station (or PCell) may refer to the base station handling the primary communication channel of a UE and RACH (Random Access Channel). Secondary serving base station (or SCell) may refer to a base station also in communication with the UE.

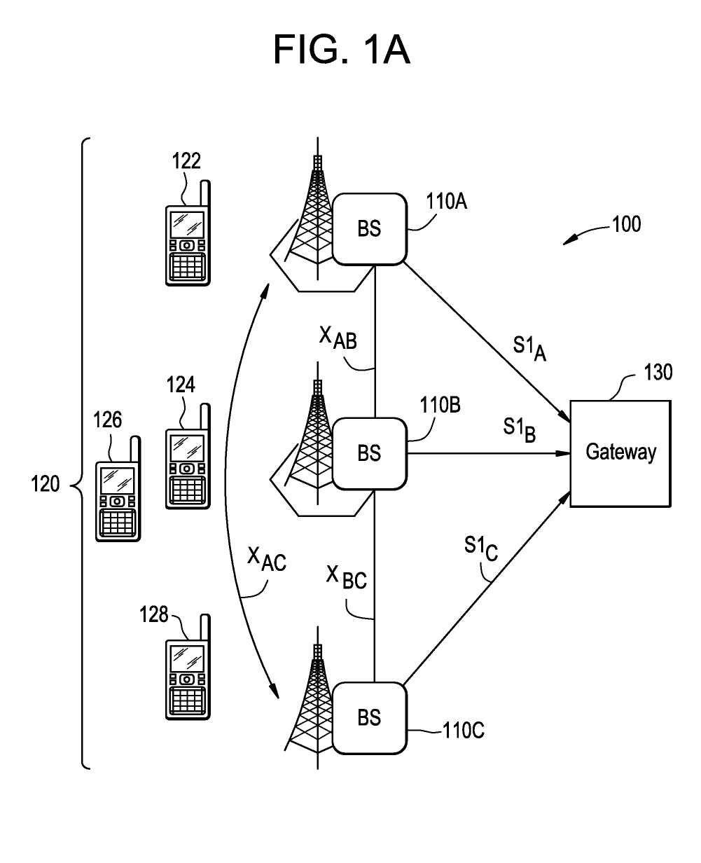

FIG. 1A illustrates a system according to an example embodiment. A wireless communications system 100 may follow, for example, a Long Term Evolution (LTE) protocol. It should be understood that example embodiments are not limited to LTE.

Wireless communications system 100 includes a first base station 110A; a second base station 110B; a third base station 110C; a plurality of user equipments (UEs) 120 including first UE 122; second UE 124; third UE 126; and fourth UE 128; a Gateway/MME 130. Each base station 110A-110C may have a coverage area which may include a single cell or a plurality of cells. Moreover, the base stations 110A-110C may communicate with the UEs using TDD and/or FDD. For example, a single base station may be equipped with a TDD carrier and an FDD carrier. In this example, one of the TDD carrier and the FDD carrier operates in a primary cell and the other carrier operates in the secondary cell. Moreover, the primary cell and secondary cell do not need to be co-located geographically.

The term carrier may refer to component carrier, as discussed in Rel-10/11 carrier aggregation (CA) of LTE.

The gateway/MME 130 may include one or more processors and an associated memory operating together to achieve their respective functionality. The gateway/MME 130 may include one or more mobility management entities (MME), a Home eNB Gateway, a security gateway and/or one or more operations, administration and management (OAM) nodes (not shown). Further, the MME may include the OAM node. For the convenience of illustration, the gateway/MME 130 is illustrated as a single node, however, it should be understood that the gateway/MME 130 may be represented as separate nodes.

Any one of the gateway/MME 130, base stations 110A-110C and UEs 120 may be referred to as a network element.

It should be noted that the wireless communications system 100 is not limited to the features shown therein. These features are shown for explanation of example embodiments. It should be understood that the wireless communications system 100 may include common features such as a home subscriber server (HSS), an Off-line charging System (OFCS), a serving gateway (S-GW), and a public data network (PDN) gateway (P-GW).

The UEs 120 may be in wireless communication with at least a respective one of the first base station 110A, the second base station 110B and the third base station 110C. The UEs 120 may be, for example, mobile phones, smart phones, computers, or personal digital assistants (PDAs). The first base station 110A, the second base station 110B and the third base station 110C communicate with each other over interfaces such as X2 interfaces. More specifically, the first base station 110A and the base station 110B communicate over an interface X_{AB}, the third base station 110C and the second base station 110B communicate over an interface X_{BC} and the first base station 110A and the third base station 110C communicate over an interface X_{AC}.

The gateway/MME 130 communicates with the first base station 110A, the second base station 110B and the third base station 110C over S1 interfaces S1_{A}, S1_{B} and S1_{C}, respectively.

For a particular UE 120, one of the carriers in one of the base stations 110A-110C operates as the primary serving cell and the other carrier in the same (if the base station includes multiple carriers) or different base station may operate as a secondary serving cell. The UE is configured to operate such that the PUCCH is always transmitted on an FDD carrier. In one example embodiment, the base stations 110A-110C dictate which serving cell the UE should use to communicate the PUCCH.

FIG. 1B illustrates a base station configured to implement carrier aggregation according to an example embodiment. As shown in FIG. 1B, the base station 110A has a cell 200 and a cell 210. In FIG. 1B, the serving cell 200 may be implemented with a TDD carrier and the serving cell 210 may be implemented with an FDD carrier or vice versa.

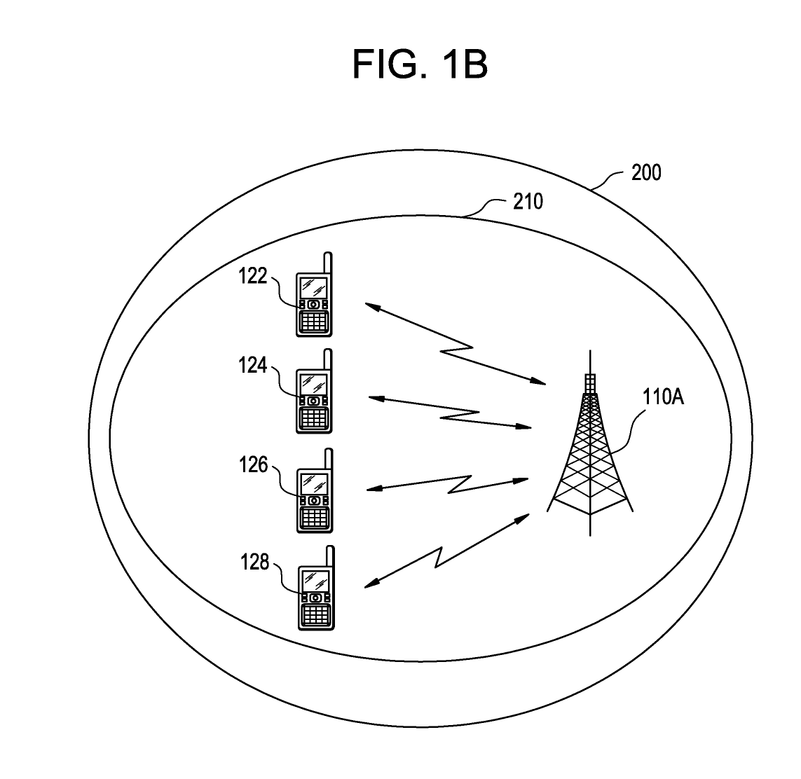

FIG. 2 shows an example when one TDD carrier and one FDD carrier are aggregated. In FIG. 2, conventionally the TDD carrier is used in the PCell and the FDD carrier is used in the SCell. Further, the PUCCH is always transmitted by the UE to the PCell, i.e., the TDD carrier in FIG. 2. This means that PUCCH is only available in the TDD UL subframes.

As shown in FIG. 2, when the FDD carrier in the base station is used to perform scheduling for the PDSCH, the existing HARQ timing cannot be easily extended.

More specifically, the FDD carrier in the base station transmits some DL transmissions. Consequently, if the FDD carrier follows the HARQ timing of the FDD carrier, there is no PUCCH opportunity in some subframes in the primary cell when the primary cell is a TDD carrier.

On the other hand, if the FDD carrier in the base station follows the HARQ timing of the TDD carrier, there is no HARQ timing defined for the FDD subframes that correspond to the TDD UL subframes. More specifically, in TDD, HARQ timing is defined for DL subframes only. However, in FDD, UL transmissions can occur in all the subframes. Therefore, there is no HARQ timing defined for the FDD subframes that correspond to the TDD UL subframes. In FIG. 2, S (special) subframes, include a short DL period, a guard period, and a short UL period.

In an example embodiment, the UE 120 transmits the PUCCH on a FDD carrier when TDD-FDD CA is used, regardless of whether the FDD carrier is a PCell or SCell. In this case, the FDD carrier can always follow its own timing, while the TDD carrier can follow its own timing or the timing of the FDD carrier.

When there is more than one FDD carrier in aggregation, which FDD carrier is selected for timing can be either defined in the specifications (e.g. based on the cell index), or signaled using higher layer signaling.

This solution solves the PDSCH HARQ timing issue. Other than solving the timing issue of the PDSCH HARQ, example embodiments also have the benefit of more evenly distributing uplink control information among UL subframes, because the PUCCH is available in all the subframes in a FDD carrier.

In an example embodiment, there are one TDD carrier and one FDD carrier aggregated for one of the UEs 120, and the TDD carrier is used in the PCell. The UE 120 is specified or configured to transmit the PUCCH using the FDD carrier, which is an SCell, instead of a PCell. Because the UE 120 transmits the PUCCH on a FDD carrier, the PDSCH HARQ timing in self-scheduling on the FDD carrier follows the timing of the FDD carrier, while the HARQ timing on the TDD follows the timing of either the FDD carrier or the TDD carrier. The PUCCH also carries CSI and SR for the UE as defined in LTE standards.

In another example embodiment, there are two TDD carriers and two FDD carriers aggregated for the UE 120, and one of the TDD carriers is configured in the PCell. The base station (e.g., 110A) configures one of the FDD carriers to carry PUCCH, which carries HARQ for all the carriers, CSI and SR.

In another example embodiment, the UE 120 operates with only a TDD carrier. SCell addition is then performed to aggregate an FDD carrier. SCell addition/deletion may be configured by higher layer signaling. As a result, the PUCCH switches automatically to the FDD carrier, even though the TDD carrier remains in the PCell.

In another example embodiment, the UE 120 operates with a TDD carrier as the SCell, aggregated with an FDD carrier as the PCell, and the PUCCH is transmitted on the FDD carrier. A reconfiguration is then performed to make the TDD carrier operate in the PCell using higher layer signaling. Following the reconfiguration, the PUCCH remains on the FDD carrier, even though the TDD carrier is now in the PCell.

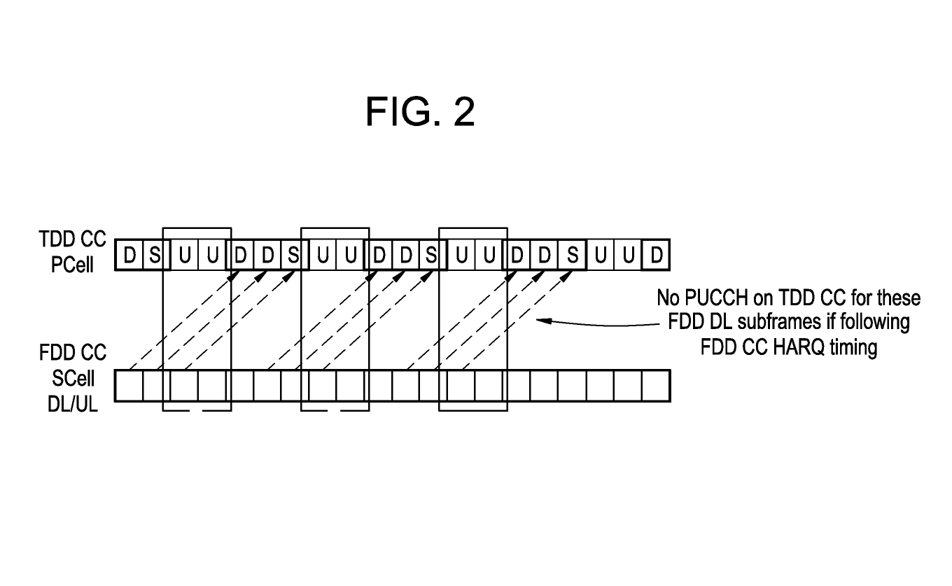

FIG. 3 illustrates a method of receiving uplink control information. The method of FIG. 3 may be performed by any of the base stations 110A-110C.

At S305, the network element identifies at least a first and a second cell in communication with a user equipment (UE), the first cell being configured to communicate using time-division duplex (TDD) transmissions and the second cell being configured to communicate using frequency-division duplex transmissions (FDD), one of the first and second cell being a primary serving cell to the UE.

At S310, the network element configures and indicates to the UE to transmit uplink control channel information on a frequency-division duplex carrier, based on the specification, independent of which of the first and second cell is the primary serving cell.

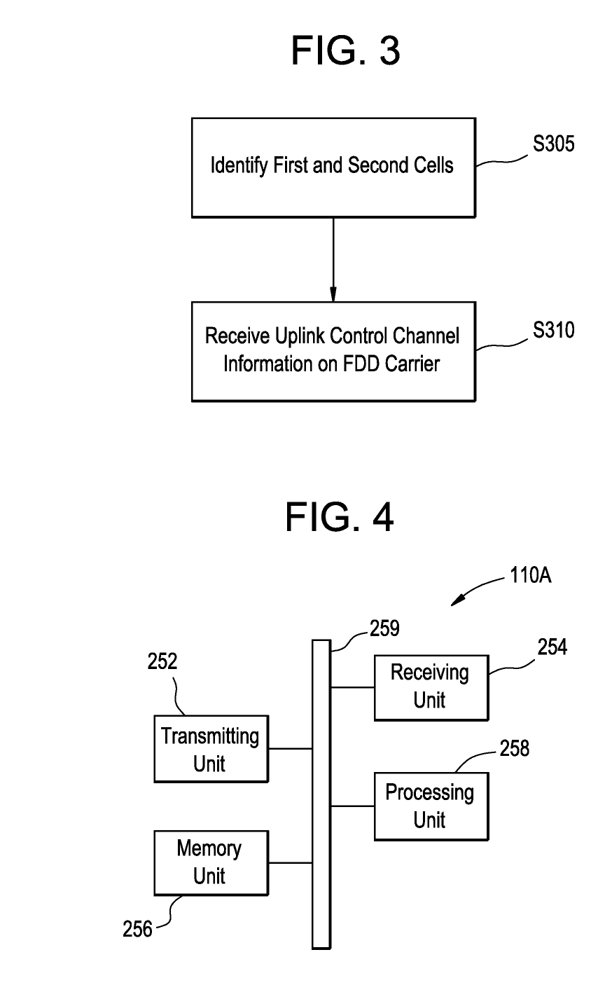

FIG. 4 illustrates an example embodiment of a network element such as the base station 110A. It should be also understood that the base station 110A may include features not shown in FIG. 4 and should not be limited to those features that are shown.

Still referring to FIG. 4, the base station 110A may include, for example, a data bus 259, a transmitting unit 252, a receiving unit 254, a memory unit 256, and a processing unit 258.

The transmitting unit 252, receiving unit 254, memory unit 256, and processing unit 258 may send data to and/or receive data from one another using the data bus 259. The transmitting unit 252 is a device that includes hardware and any necessary software for transmitting wireless signals including, for example, data signals, control signals, and signal strength/quality information via one or more wireless connections to other network elements in the wireless communications network 100.

The receiving unit 254 is a device that includes hardware and any necessary software for receiving wireless signals including, for example, data signals, control signals, and signal strength/quality information via one or more wireless connections to other network elements in the network 100.

The memory unit 256 may be any device capable of storing data including magnetic storage, flash storage, etc. The memory unit 256 is used for data and controlling signal buffering and storing for supporting pre-scheduling and the scheduled data transmissions and re-transmissions.

The processing unit 258 may be any device capable of processing data including, for example, a microprocessor configured to carry out specific operations based on input data, or capable of executing instructions included in computer readable code.

For example, the processing unit 258 is capable of identifying at least a first and a second cell in communication with a user equipment (UE), the first cell being configured to communicate using time-division duplex (TDD) transmissions and the second cell being configured to communicate using frequency-division duplex transmissions, one of the first and second cell being a primary serving cell to the UE and control the UE to transmit uplink control channel information on a frequency-division duplex carrier independent of which of the first and second cell is the primary serving cell.

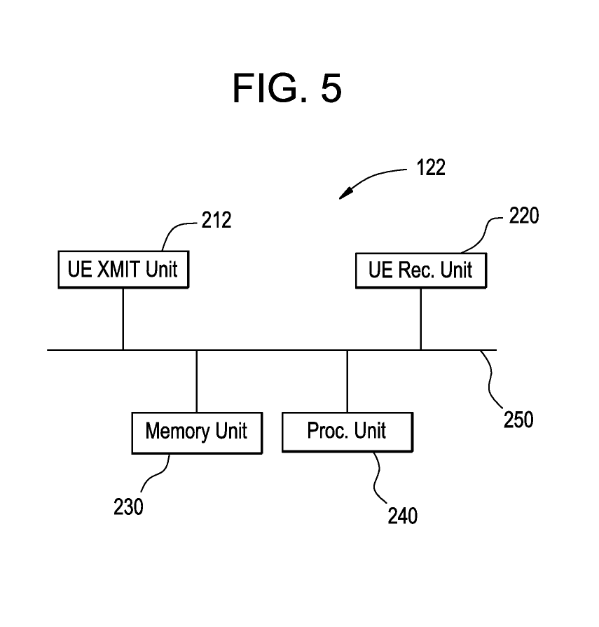

FIG. 5 illustrates an example embodiment of the UE (e.g., 122 of FIG. 1A). It should be also understood that the UE 122 may include features not shown in FIG. 5 and should not be limited to those features that are shown.

The UE 122 is configured to determine channel conditions, speed and location information.

The UE 122 may include, for example, a transmitting unit 212, a UE receiving unit 220, a memory unit 230, a processing unit 240, and a data bus 250.

The transmitting unit 212, UE receiving unit 220, memory unit 230, and processing unit 240 may send data to and/or receive data from one another using the data bus 250. The transmitting unit 212 is a device that includes hardware and any necessary software for transmitting wireless signals on the uplink (reverse link) including, for example, data signals, control signals, and signal strength/quality information via one or more wireless connections to other wireless devices (e.g., base stations).

The UE receiving unit 220 is a device that includes hardware and any necessary software for receiving wireless signals on the downlink (forward link) channel including, for example, data signals, control signals, and signal strength/quality information via one or more wireless connections from other wireless devices (e.g., base stations). The UE receiving unit 220 receives information from a serving base station.

The memory unit 230 may be any storage medium capable of storing data including magnetic storage, flash storage, etc.

The processing unit 240 may be any device capable of processing data including, for example, a microprocessor configured to carry out specific operations based on input data, or capable of executing instructions included in computer readable code. For example, the processing unit 240 is configured to identify at least a first and a second cell in communication with the UE, the first cell being configured to communicate using time-division duplex (TDD) transmissions and the second cell being configured to communicate using frequency-division duplex transmissions, one of the first and second cell being a primary serving cell to the UE.

Example embodiments being thus described, it will be obvious that the same may be varied in many ways. Such variations are not to be regarded as a departure from the spirit and scope of example embodiments, and all such modifications as would be obvious to one skilled in the art are intended to be included within the scope of the claims.

What is claimed is:

1. A method of receiving uplink control information in a communication system having at least a first and a second cell, the first cell using a time-division duplex (TDD) carrier and configured to communicate using TDD transmissions and the second cell using a frequency-division duplex carrier and configured to communicate using FDD transmissions, one of the first and second cells being a primary serving cell the method comprising:
receiving uplink control channel information on the frequency-division duplex carrier independent of which one of the first and second cells is the primary serving cell.

2. The method of claim 1, wherein the uplink control channel information is received on the frequency-division duplex carrier.

3. The method of claim 2, wherein the second cell is a secondary serving cell.

4. The method of claim 1, wherein the second cell has a first coverage area and the first cell has a second coverage area, the second coverage area being larger than the first coverage area.

5. The method of claim 1, wherein the second cell has a first coverage area and the first cell has a second coverage area, the second coverage area being smaller than the first coverage area.

6. The method of claim 1, wherein the first cell is a secondary serving cell, the method further comprising:
configuring communications with a user equipment (UE) such that the first cell is the primary serving cell.

7. The method of claim 1, wherein multiple cells using FDD are aggregated with at least one cell that uses TDD, and an uplink control channel is transmitted in one of the multiple cells.

8. The method of claim 7, wherein which FDD using cell carries the uplink control channel is pre-defined.

9. The method of claim 7, wherein which FDD using cell carries the uplink control channel is signaled using higher layer signaling.

10. The method of claim 1, wherein the control channel information includes HARQ feedback for a downlink data channel for the first cell and the second cell.

11. The method of claim 10, wherein HARQ feedback timing for the second cell follows timing of the FDD transmissions.

12. The method of claim 10, wherein HARQ feedback timing for the first cell follows timing of the TDD transmissions.

13. The method of claim 10, wherein HARQ feedback timing for the first cell follows timing of the second cell.

14. The method of claim 1, wherein the uplink control channel information includes channel state information (CSI).

15. The method of claim 1, wherein the uplink control channel information includes a scheduling request (SR).

16. A network element comprising:
a memory; and
a processor configured with at least a first and a second cell the first cell being a time-division duplex (TDD) carrier and configured to communicate using TDD transmissions and the second cell being a frequency-division duplex carrier and configured to communicate using FDD transmissions, one of the first and second cell being a primary serving cell, and
the processor configured to receive channel information on the frequency-division duplex carrier independent of which of the first and second cell is the primary serving cell.

17. The network element of claim 16, wherein the processor is configured to receive the uplink control channel information on the frequency-division duplex carrier.

18. The network element of claim 17, wherein the second cell is a secondary serving cell.

19. The network element of claim 16, wherein the second cell has a first coverage area and the first cell has a second coverage area, the second coverage area being larger than the first coverage area.

20. A user equipment (UE) comprising:
a processor configured to identify first and second cells with which the UE is in communication, the first cell being configured to communicate using a time division duplex (TDD) carrier and the second cell being configured to communicate using a frequency division duplex (FDD) carrier, one of the first and second cell being a primary serving cell to the UE; and
a transmitter, coupled to the processor via a data bus and said transmitter being configured to transmit uplink control channel information on the frequency-division duplex carrier independent of which one of the first and second cells is the primary serving cell.
